(19) United States
(12) Patent Application Publication
(10) Pub. No.: US 2017/0363760 A1
(43) Pub. Date: Dec. 21, 2017

(54) MULTI-VESSEL SEISMIC DATA ACQUISITION SYSTEM

(71) Applicant: CGG SERVICES SAS, Massy Cedex (FR)

(72) Inventors: Thomas MENSCH, Paris (FR); Damien GRENIE, Limours (FR); Nicolas BOUSQUIE, Longpont sur Orge (FR)

(21) Appl. No.: 15/528,210

(22) PCT Filed: Dec. 4, 2015
(86) PCT No.: PCT/IB2015/002494

§ 371 Date: May 19, 2017

Related U.S. Application Data
(60) Provisional application No. 62/088,030, filed on Dec. 5, 2014.

(51) Int. Cl. G01V 1/38

(52) U.S. Cl. CPC G01V 1/3808

(57) ABSTRACT

A multi-vessel seismic data acquisition system having a first vessel towing a streamer containing a plurality of seismic receivers and a pair of seismic sources along a first shot line. At least one additional vessel tows only a single seismic source. Each additional single seismic source is spaced from the pair of seismic sources an offset distance in at least one of an inline direction and a crossline direction to the first shot line to define a first bin grid having a first bin size for the first vessel and a second bin grid having a second bin size for each additional vessel.

### CROSS REFERENCE TO RELATED APPLICATIONS

This application claims priority and benefit from U.S. Provisional Patent Application No. 62/088,030, filed Dec. 5, 2014, for “Offset Dependent Acquisition Bin Grid for Multi-Vessel Seismic Operations”, the entire contents of which is incorporated herein by reference.

### TECHNICAL FIELD

Embodiments of the subject matter disclosed herein generally relate to methods and systems for conducting marine-based seismic surveys.

### BACKGROUND

The goal of seismic data acquisition is to achieve uniform sampling over the survey area. Usually a uniform grid of rectangular cells or bins is set up and each recorded data/trace is assigned within a particular bin if the midpoint (between source and receiver) falls within that bin. In towed streamer marine acquisition, the acquisition bin size is determined by the acquisition geometry. The inline bin size of most marine streamer acquisitions is determined by the seismic trace interval along the streamers, which is typically about 12.5 m. The corresponding inline bin size is 6.25 m. The crossline bin size depends on the streamer separation and the source array configuration, i.e., the number of sources behind the vessel, as expressed in the following equation:

$$crossline bin size = \frac{streamer interval}{2 \times number of sources} .$$

A typical streamer separation interval of 100 m combined with two sources yields a crossline bin size of 25 m.

In practice, the bin size of the two-dimensional (2D) acquisition grid is determined to provide an adequate sampling of the subsurface. For a given interval velocity and dip, the bin size is directly linked to the dominant or maximum frequency of the signal. Considering that high frequencies are attenuated at long offset and large depth, the concept of Fresnel zone, whose size is increasing with offset and the existing interpolation or regularization algorithms, the bin size can be increased with offset without damaging the quality of the imaging results. That is especially true for deep seismic target.

Increasing the number of sources used in the seismic survey improves illumination while degrading the source density. Adding extra source vessels on a survey may significantly increase the inline source sampling compared to conventional 3D acquisition. For instance, dual vessel operation with a source vessel sailing about one cable length ahead of a streamer vessel effectively doubles the streamer length, which results in long offset ranges. However, with this configuration, the effective inline shot spacing is doubled in comparison to single vessel operations.

Multi-vessel acquisitions have a constraint imposed by the relationship between number of sources, vessel speed, shot sampling and record length. The standard sequential shooting strategy applied to dual vessel operation yields longer shot-points intervals (compared to single vessel operation), which results in lower density of coverage. Therefore, a multi-vessel marine seismic survey that provides improved grid bin coverage while avoiding longer shot-point intervals is desired.

### SUMMARY

Exemplary embodiments are directed to systems and methods that acquire marine seismic data in the context of multi-vessel operations. Acquisition geometries are used such that the resulting acquisition grid is multi-scale. The multi-scale grid depends on the source and receiver offset ranges for the seismic data. For example, a small bin size is associated with short offsets, and a larger bin size is associated with larger offsets. Variable grid bin sizes or multi-scale grids facilitate multi-scale processing. For example, short offset data can be processed with small bins, while long offset uses large bins. Multi-scale grids are achieved by combining different source array configurations, e.g., single source and dual source configurations, depending on the location of the source vessels with respect to the seismic receiver spread.

An embodiment is directed to a multi-vessel seismic data acquisition system having a first vessel towing a streamer containing a plurality of seismic receivers and a pair of seismic sources along a first shot line and at least one additional vessel towing only a single seismic source. Each additional single seismic source is spaced from the pair of seismic sources an offset distance in at least one of an inline direction and a crossline direction to the first shot line to define a first bin grid having a first bin size for the first vessel and a second bin grid having a second bin size for each additional vessel. In one embodiment, the additional vessel tows the single seismic source along a predetermined zig-zag path to introduce randomization between a location of the single source and seismic receivers in the streamer.

In one embodiment, the pair seismic sources and the seismic receivers define the first bin grid having the first bind size with a first bin grid width, and the single seismic source and the seismic receivers define the second bin grid offset from the first bin grid in at least one of the inline direction and the crossline direction and having the second bin size with a second bin grid width greater than the first bin grid width. The second bin grid is separate from the first bin grid. In one embodiment, the additional vessel is towing the single seismic source along the first shot line such that the single seismic source is spaced from the first vessel and pair of seismic sources in only the inline direction along the first shot line.

In another embodiment, the additional vessel is towing the single seismic source along a second shot line space from the first shot line by a predefined crossline distance. The additional vessel and single seismic source are located on the second shot line ahead of a position of the first vessel and pair of seismic sources on the first shot line. In one embodiment, the streamer containing the seismic receivers has a crossline width that increases from a lead end to a tail end of the streamer to define a fan shape. The pair of seismic sources and the seismic receivers define the first bin grid having a first bin grid width, and the single seismic source and the seismic receivers define the second bin grid offset from the first bin grid in at least one of the inline direction and the crossline direction and having a second bin grid width that is greater than the first bin grid width.

In one embodiment, the at least one additional vessel includes two additional vessels located on opposite sides of the first shot line. The streamer has a receiver spread with a width for the plurality of seismic receivers, and each one of the two additional vessels and single seismic sources are spaced from the first vessel and pair of seismic sources in a crossline distance equal to the width of the receiver spread. In one embodiment, the pair of seismic sources and the seismic receivers define the first bin grid having a first bin grid width, and the single seismic sources and the seismic receivers define the second bin grid and a third bin grid each offset from the first bin grid in at least one of the inline direction and the crossline direction and comprising a second bin grid width and a third bin grid width greater than the first bin grid width. The first, second and third bin grids in a crossline direction define a total crossline acquisition width for the multi-vessel seismic data acquisition system.

An embodiment is directed to a method for acquiring seismic data using a multi-vessel seismic data acquisition system. This method includes towing a streamer containing a plurality of seismic receivers and a pair of seismic sources along a first shot line using a first vessel and towing at least one single seismic source using at least one additional vessel such that the at least one single source is spaced from the pair of seismic sources in an offset distance in at least one of an inline direction and a crossline direction to the first shot line adapted to define a first bin grid having a first bin size for the first vessel and a second bin grid having a second bin size for each additional vessel.

In one embodiment, the pair seismic sources and the seismic receivers are used to obtain short offset seismic data that define the first bin grid with the first bin size having a first bin grid width, and the single seismic source and the seismic receivers are used to obtain large offset seismic data that define the second bin grid offset from the first bin grid in at least one of the inline direction and the crossline direction and having the second bin size with a second bin grid width greater than the first bin grid width, the second bin grid separate from the first bin grid.

In one embodiment, the single seismic source is towed with the additional vessel along the first shot line such that the single seismic source is spaced from the first vessel and pair of seismic sources only in the inline direction along the first shot line. In one embodiment, the single seismic source is towed with the additional vessel along a second shot line space from the first shot line by a predefined crossline distance, and the single seismic source is located on the second shot line ahead of a position of the first vessel and pair of seismic sources on the first shot line.

In one embodiment, a fan shaped streamer that contains the seismic receivers is defined to have a crossline width that increases from a lead end to a tail end of the streamer. The pair of seismic sources and the seismic receivers are used to obtain short offset seismic data that define the first bin grid having a first bin grid width, and the single seismic source and the seismic receivers are used to obtain large offset seismic data that define the second bin grid offset from the first bin grid in at least one of the inline direction and the crossline direction and having a second bin grid width that is greater than the first bin grid width.

In one embodiment, the single seismic source is towed with the additional vessel along a predetermined zig-zag path to introduce randomization between a location of the single source and seismic receivers in the streamer. In another embodiment, each source in the pair of sources and the single source is activated using a sequential activation sequence. Alternatively, the pair of sources is activated simultaneously, and the single source is activated after activation of the pair of sources.

In one embodiment, the streamer has a width, and two additional vessels are towed on opposite sides of the first shot line. Each one of the two additional vessels and single seismic sources is spaced from the first vessel and pair of seismic sources in a crossline distance equal to the width of the streamer. In one embodiment, the pair of seismic sources and the seismic receivers are used to obtain short offset seismic data that define the first bin grid having a first bin grid width, and the single seismic sources and the seismic receivers are used to obtain large offset seismic data that define the second bin grid and a third bin grid each offset from the first bin grid in at least one of the inline direction and the crossline direction and having a second bin grid width and a third bin grid width greater than the first bin grid width. The first, second and third bin grids in a crossline direction define a total crossline acquisition width for the multi-vessel seismic data acquisition system. In one embodiment, the pair of sources are activated simultaneously, and all single sources are activated simultaneously after activation of the pair of sources.

An embodiment is directed to a method for acquiring seismic data using a multi-vessel seismic data acquisition system that includes performing a first pass by towing a streamer comprising a plurality of seismic receivers along a first shot line using a first vessel and towing a pair of seismic sources with each one of a second vessel and a third vessel along a second shot line and a third shot line located on a first side of the first shot line and spaced from the first shot line in a crossline direction. In addition, a second pass is performed by towing the streamer along the first shot line using the first vessel and towing the pair of seismic sources with each one of the second vessel and the third vessel along the second shot line and the third shot line located on a second side of the first shot line opposite the first side and spaced from the first shot line in a crossline direction. A third pass is performed by towing the streamer and a pair of seismic sources along the first shot line using the first vessel, towing a single seismic source with the second vessel along the first side of the shot line and spaced from the first shot line in a crossline direction and towing a single source with the third vessel along the third shot line located on the second side of the first shot line and spaced from the first shot line in a crossline direction.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a representation of an embodiment of a multi-vessel data acquisition system with inline offset;

FIG. 2 is a representation of an embodiment of a multi-vessel data acquisition system with inline and crossline offset;

FIG. 3 is a flowchart illustrating an embodiment of a regularization algorithm applied to an irregular bin grid;

FIG. 4 is a representation of an embodiment of a multi-vessel data acquisition system with fan shaped streamer and inline offset;

FIG. 5 is a representation of an embodiment of a multi-vessel data acquisition system with inline offset and zig-zag shot line;

FIG. 6 is a representation of an embodiment of a multi-vessel data acquisition system with two additional vessels and crossline offset;

FIG. 7 is a representation of an embodiment of a multi-vessel data acquisition system with two additional vessels, crossline offset and zig-zag shot lines;

FIG. 8 is a representation of a multi-pass acquisition operation of a multi-vessel data acquisition system;

FIG. 9 is a Rose diagram of a regular multi-pass acquisition operation;

FIG. 10 is a Rose diagram of a multi-pass acquisition operation with a mixed source array configuration;

FIG. 11 is a flow chart illustrating an embodiment of a method for acquiring seismic data using a multi-vessel seismic data acquisition system; and

FIG. 12 is a flow chart illustrating another embodiment of a method for acquiring seismic data using a multi-vessel seismic data acquisition system.

### DETAILED DESCRIPTION

The following description of the embodiments refers to the accompanying drawings. The same reference numbers in different drawings identify the same or similar elements. The following detailed description does not limit the invention. Instead, the scope of the invention is defined by the appended claims. Some of the following embodiments are discussed, for simplicity, with regard to local activity taking place within the area of a seismic survey. However, the embodiments to be discussed next are not limited to this configuration, but may be extended to other arrangements that include regional activity, conventional seismic surveys, etc.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

Exemplary embodiments of systems and methods optimize the number of seismic sources on multi-vessel seismic surveys by using source array configurations including one source array and two or more source arrays such as a dual source array configuration. In one embodiment, the marine seismic source includes a plurality of source elements called air guns, which are supplied with high-pressure air. An air-gun array contains 3-6 sub-arrays called strings, each string containing 6-10 individual guns, so that the array usually involves between 18 and 60 guns,

The source array configurations depend on the locations of the vessels with respect to the seismic receiver spread. Exemplary embodiments take advantage of existing interpolation/regularization algorithms and provide improvements in data quality, efficiency and flexibility. Regarding data quality, the length of the firing source sequence is reduced, which improves the inline source sampling. Improvements in efficiency result from reducing the total number of sources in multi-vessel surveys. This facilitates the addition of or more source vessels arranged to acquire a wider azimuth dataset in one pass while preserving the initial inline source sampling. In multi-pass WAZ acquisition, this reduces the number of passes. Improvements in flexibility are achieved by allowing source vessels in single source array configurations to have an available slot for towing another source array with different seismic features, e.g., low frequency source, seismic vibrator or a source with a larger volume

Exemplary embodiments are compatible with fan mode acquisition, simultaneous source technology, broadband acquisition and irregular seismic receiver spread, i.e., increasing streamer separation from inner cables to outer cables. In general, the sources, including pairs of sources and single sources, towed by different vessels can be offset or spaced apart in at least one of an inline and crossline direction based on the shot lines traversed by the vessels and sources. This spacing can be predetermined, constant and variable (including discrete and continuous variability). In one embodiment, this spacing is predetermined to generate the desired bin imprints and bin grid widths as discussed herein. For example, each additional single seismic source is spaced from the pair of seismic sources in an offset distance in at least one of an inline direction and a crossline direction adapted to define a first bin grid and bin size for the first vessel and at least another bin grid and bin size for each additional vessel.

Referring initially to FIG. 1, an exemplary embodiment of a dual vessel acquisition geometry arrangement for acquiring narrow azimuth (NAZ) long offset seismic data 100 is illustrated. The dual vessel acquisition arrangement includes a first source vessel 104 and a second source vessel 102. The first source vessel tows a pair of sources, i.e., a first source 110 and a second source 112, in a dual source array configuration. The second vessel tows a single source 106 and is located ahead of the first vessel in an in-line configuration along a common shot line 108. The first vessel also tows at least one streamer 114 containing a plurality of seismic receivers.

The offsets or spacing between the sources associated with each vessel and the receivers in the streamers define the seismic acquisition bin grids. As used herein and illustrated in the figures, a bin grid is a gathering of bins or cells. A bin, or cell, has a specific size and is generally rectangular. Each source vessel and streamer defines a bin grid. Therefore, two source vessels and a single streamer define two different or separate bin grids, for example, a bin grid having a relatively small bin size for short offsets, i.e., between seismic source and seismic receiver, and a bin grid having a relatively larger bin size for larger offsets. For a given seismic data acquisition, the two bin grids do not change; however, the two bin grids can overlap.

The bin imprint, or midpoint imprint, is associated with the bin grid and is illustrated in the figures as a plurality of parallel bands for the associated bin grid. These bands, while associated with one of the bin grids, are not the entire bin grid, but the imprint midpoints made during the seismic acquisition by shooting a source or sources associated with one of the source vessels and receiving the resulting seismic signal by a seismic receiver in the streamer.

As illustrated in FIG. 1, a first dataset generated from both the first and second sources 110 and 112 of the first vessel 104 is associated with a fine acquisition bin grid (referred to as a short offset grid). A second dataset generated from the single source 106 of the second vessel 102 is associated with a coarse acquisition bin grid (referred to as a long offset grid).

As illustrated, the first and second sources 110 and 112 associated with the first vessel 104 define a first midpoint imprint associated with a first bin grid 120, and the single source 106 associated with the second vessel 102 defines a second midpoint imprint associated with a second bin grid 122. The coverage of the second bin grid corresponds to long offset seismic data, and the coverage of the first bind grid corresponds to near offset seismic data. The first bin grid has a first crossline bin or cell size 116 or bin or cell width, and the second bin grid has a second crossline bin or cell size 118 or bin or cell width. The second crossline bin size is larger than the first crossline bin size, because crossline bin size depends both on the number of sources and the streamer separation. Therefore, the second acquisition bin grid for acquiring long offset data is coarser than the first acquisition bin grid used for near offset data.

As said above, the shot point interval associated with the acquisition geometry arranged using two vessels is doubled compared to conventional single vessel NAZ acquisition. However, because the second source vessel is activated for acquiring only long offset seismic data, a single source is used, reducing the total number of seismic sources in the acquisition geometry arrangement from 4 to 3. This reduced number of seismic sources, facilitates an increase in the number of firings of each seismic source during the seismic survey. An increased number of source firings produces an increased number of seismic traces. This increase in the number of seismic traces yields an improved image of the subsurface.

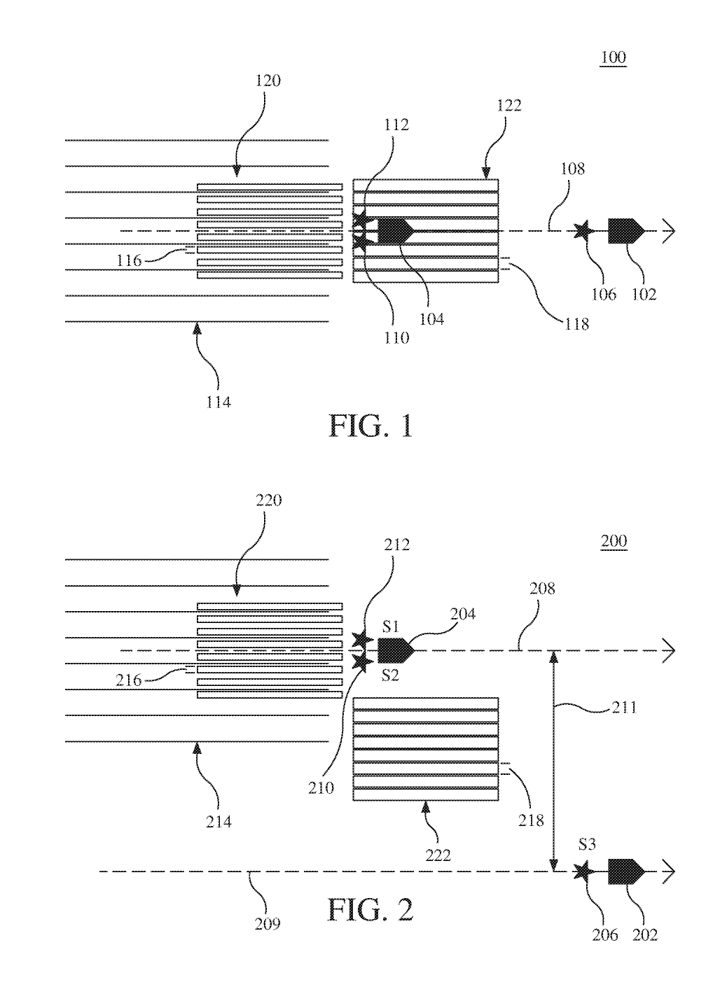

Referring to FIG. 2, another exemplary embodiment of a dual vessel acquisition geometry arrangement for acquiring NAZ long offset seismic data 200 is illustrated. The dual vessel acquisition arrangement includes a first source vessel 204 and a second source vessel 202. The second vessel tows a single source 206 and is located ahead of the first vessel. However, instead of be located in an in-line configuration along a common first shot line 208, the second vessel is located along a second shot line 209 that is offset in a crossline direction from the first shot line by a given crossline distance 211. The first vessel tows a pair of sources, i.e., a first source 210 and a second source 212, in a dual source array configuration. The first vessel also tows at least one streamer 214 containing a plurality of seismic receivers. The offsets between the sources associated with each vessel and the receivers in the streamer define the seismic acquisition bin grids as defined herein.

As illustrated, the sources associated with the first vessel define a first bin grid 220, and the source associated with the second vessel defines a second bin grid 222. The coverage of the second bin grid corresponds to long offset seismic data, and the coverage of the first bind grid corresponds to near offset seismic data. The first bin grid has a first crossline bin size 216 or bin width, and the second bin grid has a second crossline bin size 218 or bin width. The second crossline bin size is larger than the first crossline bin size, because crossline bin size depends both on the number of sources and the streamer separation. Therefore, the second acquisition bin grid for acquiring long offset data is coarser than the first acquisition bin grid used for near offset data. Since the second vessel follows the second shot line, the second bin grid 222 is also offset from the first bin grid in a cross line direction.

Again, the shot point interval associated with the acquisition geometry arranged using two vessels is doubled compared to conventional single vessel NAZ acquisition. However, because the second source vessel is activated for acquiring only long offset seismic data, a single source is used, reducing the total number of seismic sources in the acquisition geometry arrangement from 4 to 3. This reduced number of seismic sources, facilitates an increase in the number of firings of each seismic source during the seismic survey. An increased number of source firings produces an increased number of seismic traces. This increase in the number of seismic traces yields an improved image of the subsurface.

In one embodiment, having obtained seismic data containing a plurality of seismic traces from the two bin grids, i.e., the first acquisition bin grid and the second acquisition bin grid, advanced regularization techniques are applied to the two acquisition bin grids to build a regular bin grid for the entire seismic dataset that is suitable for processing. Suitable regularization techniques account for the frequency band limited signals for the long offset data and the corresponding large Fresnel zone.

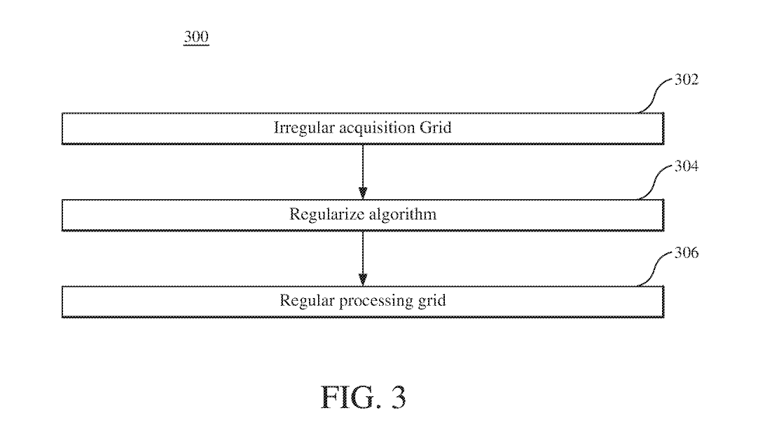

Referring to FIG. 3, an exemplary embodiment of a workflow for a method for processing the two acquisition bin grids using regularization techniques 300 is illustrated. In order to facilitate further processing, these two acquisition bin grids are regularized, i.e., moved or migrated to a common bin grid or regular processing grid. According to this method, an irregular acquisition grid is identified 302. This irregular acquisition grid is defined for both the first bin grid and the second bin as these bin grids have differing bin grid widths associated with the longer or shorter offsets. A regularization algorithm is then applied to the identified irregular acquisition grid 304. Suitable regularization algorithms are known and available in the art. Based on the application of the regularization algorithm, a regular processing grid is created 306 for both the first and second bin grids. Therefore, the first and second bin grids are regularized or translated to this common regular processing grid, and further processing can be conducted based on this regular processing grid.

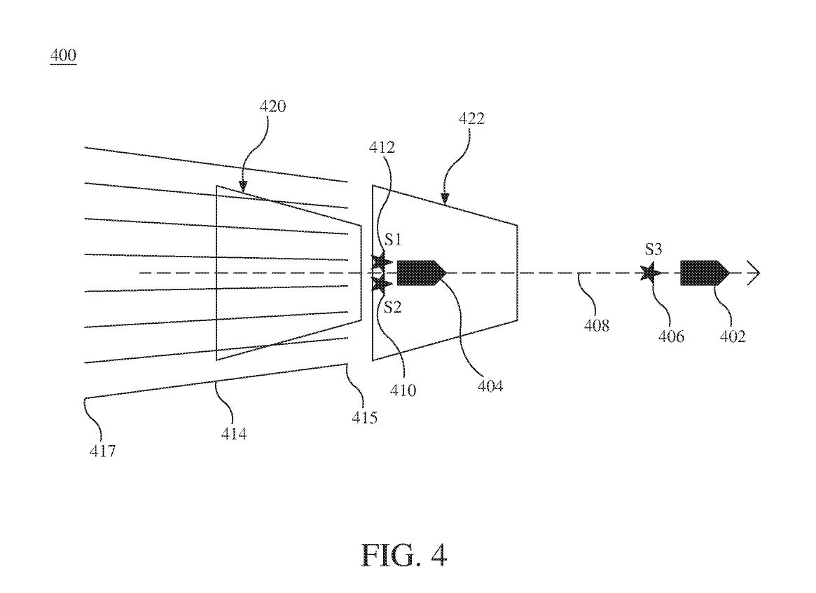

Referring now to FIG. 4, an exemplary embodiment of a dual vessel acquisition geometry and fan mode arrangement for acquiring NAZ long offset seismic data 400 is illustrated. The dual vessel acquisition arrangement includes a first source vessel 404 and a second source vessel 402. The second vessel tows a single source 406 and is located ahead of the first vessel in an in-line configuration along a common shot line 408. The first vessel tows a pair of sources, i.e., a first source 410 and a second source 412, in a dual source array configuration. The first vessel also tows at least one streamer 414 containing a plurality of seismic receivers. The streamer has a fan arrangement in which the width of the streamer containing a plurality of receivers increases from a lead end 415 to a tail end 417. The lead end is closer to the sources than the tail end. The offsets between the sources associated with each vessel and the receivers in the streamer in combination with the fan arrangement of the streamer define the seismic acquisition bin grids, as discussed herein.

As illustrated, the source associated with the second vessel defines a second bin grid 422, and the sources associated with the first vessel define a first bin grid 420. The coverage of the second bin grid corresponds to long offset seismic data, and the coverage of the first bind grid corresponds to near offset seismic data. In addition to the second bin grid having a first crossline bin size or bin width that is larger than the first crossline bin size or bin width of the first bin grid.

In the fan mode acquisition arrangement with the second source vessel located ahead of the first source vessel in an in-line arrangement, each acquisition bin grid cross-line bin size progressively increases with source and receiver offset. Allowing an overlap of the offset classes by reducing the distance between the two source vessels aids the regularization process.

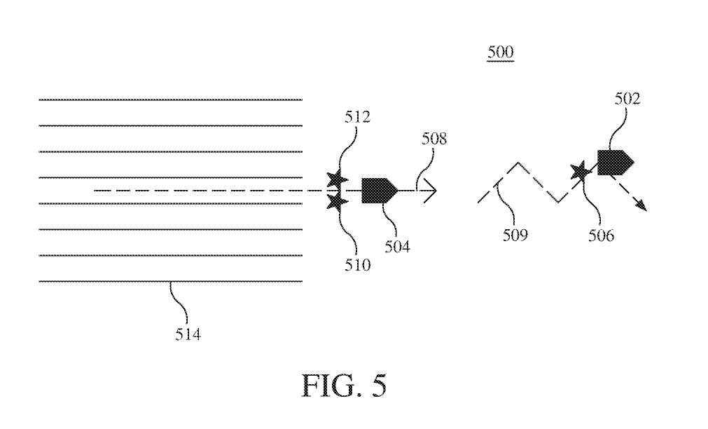

Referring now to FIG. 5, another exemplary embodiment of a dual vessel acquisition geometry arrangement for acquiring NAZ long offset seismic data 500 using a zig-zag source vessel path is illustrated. Regardless of the trajectory of the source vessel, the resulting bin grid remains unchanged. The irregular distribution of shot points resulting from the zig-zag source path, however, can improve the subsequent regularization process, e.g., based on a compressive sensing concept. The dual vessel acquisition arrangement includes a second source vessel 502 and a first source vessel 504. The second vessel tows a single source 506 and is located ahead of the first vessel. The first source vessel is moving linearly along a straight shot line 508, and tows a pair of sources, i.e., a first source 510 and a second source 512, in a dual source array configuration. The first vessel also tows at least one streamer 514 containing a plurality of seismic receivers. The offsets between the sources associated with each vessel and the receivers in the streamer define the seismic acquisition bin grids, as discussed and defined herein. The second vessel is moving along a zig-zag path 509. The zig-zag path can be random or predetermined. The zig-zag path introduces a degree of randomization in source locations. This randomization in source locations helps the regularization process.

In addition to varying the number of sources, the relative location of each source vessel and the path followed by the source vessels, the shot pattern or shooting sequence of the plurality of sources can also be varied. In one embodiment, a sequential shot strategy is used. In the sequential shot strategy, the sources in the plurality of sources are alternatively activated with a regular shot time interval. In one embodiment, this shot time interval is large, i.e., at least a predefined amount of the seismic record length. Suitable predefined amounts include, but at not limited to at least about 50% of the seismic record length. Depending on the ratio between shot time interval and the record length, an overlap of the seismic data records can occur. If an overlap occurs, a continuous recording technology is used. However, acquired data from a sequential shot strategy even with continuous recording does not require dedicated source separation algorithms, i.e., deblending techniques.

In one embodiment, the shot strategy produces a blended acquisition of seismic data. Blended seismic data, i.e., seismic data having a temporal overlap of the seismic shot records, can be acquired based on the shot sequence. In one embodiment, blended acquisition is achieved by firing simultaneously or nearly simultaneously, e.g., using a dithering approach, all the sources or a given combination or set of sources. In another embodiment, blended acquisition is achieved by reducing the shot time interval. These shooting strategies provide an increase in the shot point density and an improvement in the inline source sampling.

In one embodiment, a mixture of shooting strategies is used. For example, the above-described shooting strategies can be combined. For the first, second and third sources illustrated in FIGS. 1, 2, 4 and 5, the first and second sources associated with the first vessel are activated in a quasi-simultaneous flip/flop mode, and the third source associated with the second source vessel is activated alone. An embodiment of a source activation schedule is illustrated in Table 1 for a plurality of times T0 to T5. The first and second sources are activated nearly simultaneously at a same shooting time, e.g., T0, and the third source is activated at the next shooting time, e.g., T1. In one embodiment, the interval between two successive shooting times is about 10 seconds.

TABLE 1
Seismic Source Activation (A) Schedule

| | T0 | T1 | T2 | T3 | T4 | T5 |
|---|---|---|---|---|---|---|
| First Source | A | | A | | A | |
| Second Source | A | | A | | A | |
| Third Source | | A | | A | | A |

In one embodiment, multi-vessel seismic data acquisition is used for acquiring seismic data over a large bin grid area. This is achieved by positioning one or more additional source vessels in a parallel, cross-line arrangement with the vessel towing both the source and the streamer. Mixing the source array configuration with a dual source array on streamer and source vessel and a single source array on an additional source vessel simulates a very large seismic spread while preserving the inline source sampling.

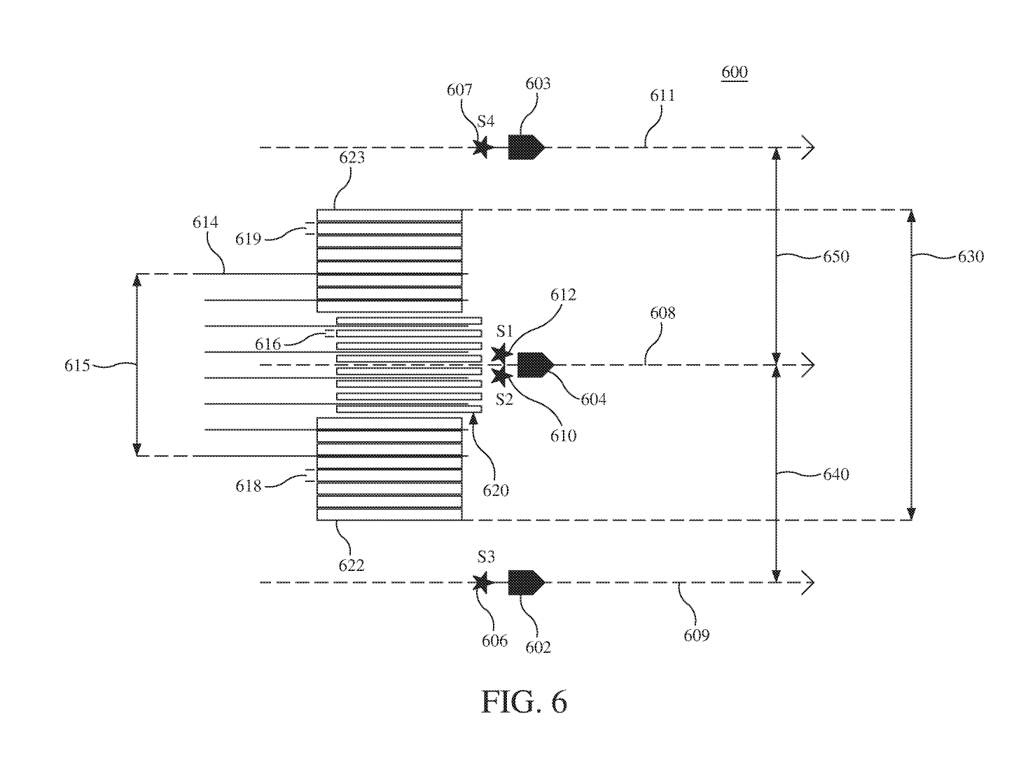

Referring to FIG. 6, an exemplary embodiment of a multi-vessel acquisition geometry for efficient NAZ acquisition 600 is illustrated. The multi-vessel acquisition arrangement includes a first source vessel 604 and at least one additional source vessel. As illustrated, the additional source vessels include a second source vessel 602 and a third source vessel 603. The first vessel tows a pair of sources, i.e., a first source 610 and a second source 612, in a dual source array configuration. The first vessel also tows at least a streamer 614 containing a plurality of seismic receivers. The second vessel tows a single third source 606, and the third vessel tows a single fourth source 607. Instead of being located in an in-line configuration along a common first shot line 608, the second vessel is located along a second shot line 609 that is offset in a crossline direction from the first shot line by a given crossline distance, and the third vessel is located along a third shot line 611 this is offset in a crossline direction from the first shot line by a given crossline distance. In one embodiment, the given crossline distance between the streamer vessel and the source vessels is about the width of the streamer or the receiver spread. The offsets between the sources associated with each vessel and the receivers in the streamer define the seismic acquisition bin grids as discussed and defined herein. The second and third vessels can be moving in alignment with the first vessel or can be located behind or in front of the first vessel. As illustrated, the second and third vessels are located slightly behind the first vessel.

As illustrated, the sources associated with the first vessel define a first bin grid 620. The source associated with the second vessel defines a second bin grid 622, and the source associated with the third vessel defines a third bin grid. The first, second and third bin grids define a total crossline acquisition width 630. The coverage of the second and third bin grids corresponds to long offset seismic data, and the coverage of the first bind grid corresponds to near offset seismic data. The first bin grid has a first crossline bin size or bin width, and the second and third bin grids have a second crossline bin size or bin width. The second crossline bin size is larger than the first crossline bin size, because crossline bin size depends both on the number of sources and the streamer separation. Therefore, the second and third acquisition bin grids for acquiring long offset data is coarser than the first acquisition bin grid used for near offset data.

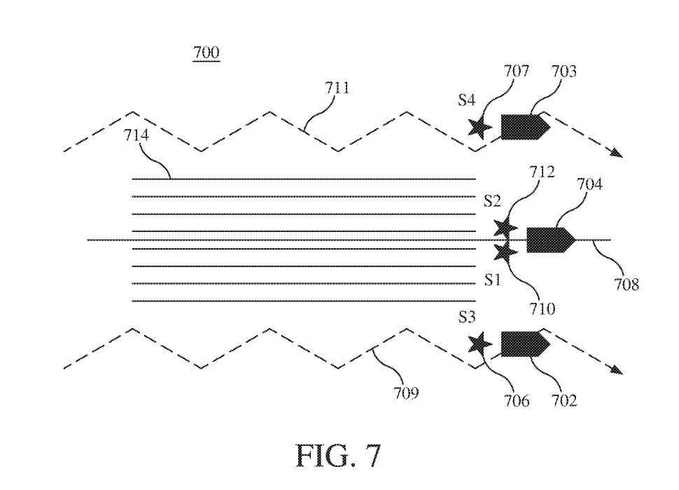

In this embodiment, the second and third source vessels follow second and third shot lines that are straight lines. Referring to FIG. 7, an exemplary embodiment of a multi-vessel acquisition geometry for efficient NAZ acquisition 700 is illustrated in which the two additional source vessels are sailing along zig-zag paths. The multi-vessel acquisition arrangement includes a first source vessel 704 and at least one additional source vessel. As illustrated, the additional source vessels include a second source vessel 702 and a third source vessel 703. The first vessel tows a pair of sources, i.e., a first source 710 and a second source 712, in a dual source array configuration. The first vessel also tows at least one streamer 714 containing a plurality of seismic receivers. The second vessel tows a single third source 706, and the third vessel tows a single fourth source 707. Instead of be located in an in-line configuration along a common first shot line 708, the second vessel traverses a second shot line 709 that is offset in a crossline direction from the first shot line by a given crossline distance, and the third vessel traverses a third shot line 711 this is offset in a crossline direction from the first shot line by a given crossline distance. The second and third shot lines are zig-zag paths. The zig-zag path can be random or predetermined. The zig-zag path introduces a degree of randomization in source locations. This randomization in source locations helps the regularization process.

In one embodiment, the given crossline distance between the streamer vessel and the source vessels is about the width of the receiver spread. The offsets between the sources associated with each vessel and the receivers in the streamer define the seismic acquisition bin grids. The second and third vessels can be moving in alignment with the first vessel or can be located behind or in front of the first vessel. As illustrated, the second and third vessels are located slightly behind the first vessel.

An embodiment of a source activation schedule is illustrated in Tables 2 and 3 for the multi-vessel configurations of FIGS. 6 and 7 for a plurality of times T0 to T5.

TABLE 2
Seismic Source Activation (A) Schedule

| | T0 | T1 | T2 | T3 | T4 | T5 |
|---|---|---|---|---|---|---|
| First Source | A | | A | | A | |
| Second Source | A | | A | | A | |
| Third Source | | A | | | | A |
| Fourth Source | | | | A | | |

TABLE 3
Seismic Source Activation (A) Schedule

| | T0 | T1 | T2 | T3 | T4 | T5 |
|---|---|---|---|---|---|---|
| First Source | A | | A | | A | |
| Second Source | A | | A | | A | |
| Third Source | | A | | A | | A |
| Fourth Source | | A | | A | | A |

In Table 2, the first and second sources are activated nearly simultaneously at a same shooting time, e.g., T0, and either the third source or the fourth source is activated at the next shooting time, e.g., T1. In Table 3, the first and second sources are activated nearly simultaneously at a same shooting time, e.g., T0, and both the third source or the fourth source are activated at the next shooting time, e.g., T1. As described above, the interval between two successive shooting times is about 10 seconds.

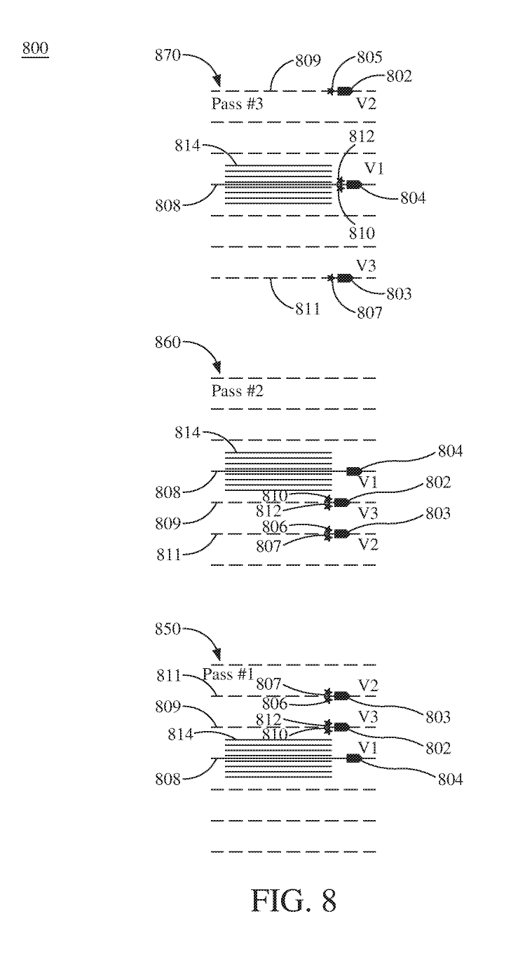

Referring now to FIG. 8, an embodiment of a multi-pass acquisition survey using a plurality of source vessels in which the source array configuration is varied between passes 800 is illustrated. During a first pass 850, the multi-vessel acquisition arrangement includes a first source vessel 804 and at least one additional source vessel. As illustrated, the additional source vessels include a second source vessel 802 and a third source vessel 803. The first vessel tows at least one streamer 814 containing a plurality of seismic receivers. The second vessel tows a pair of sources, i.e., a first source 810 and a second source 812, in a dual source array configuration. The third vessel tows a third source 806 and a fourth source 807 in a dual source array configuration. Instead of be located in an in-line configuration along a common first shot line 808, the second vessel is located along a second shot line 809 that is offset in a crossline direction from the first shot line by a given crossline distance, and the third vessel is located along a third shot line 811 this is offset in a crossline direction from the first shot line by a given crossline distance. In this pass, the second and third shot lines are located on the same side of the first shot line with the second shot line positioned between the first and third shot lines. The second and third vessels can be moving in alignment with the first vessel or can be located behind or in front of the first vessel. As illustrated, the second and third vessels are located slightly behind the first vessel.

During a second pass 860, the multi-vessel acquisition arrangement includes a first source vessel 804 and at least one additional source vessel. As illustrated, the additional source vessels include a second source vessel 802 and a third source vessel 803. The first vessel tows at least a streamer 814 containing a plurality of seismic receivers. The second vessel tows a pair of sources, i.e., a first source 810 and a second source 812, in a dual source array configuration. The third vessel tows a third source 806 and a fourth source 807 in a dual source array configuration. Instead of be located in an in-line configuration along a common first shot line 808, the second vessel is located along a second shot line 809 that is offset in a crossline direction from the first shot line by a given crossline distance, and the third vessel is located along a third shot line 811 this is offset in a crossline direction from the first shot line by a given crossline distance. In this pass, the second and third shot lines are located on the same side of the first shot line with the second shot line positioned between the first and third shot lines. However, in this second pass, the second and third shot lines are located on an opposite side of the first shot line 808 from the first pass. The second and third vessels can be moving in alignment with the first vessel or can be located behind or in front of the first vessel. As illustrated, the second and third vessels are located slightly behind the first vessel.

During a third pass 870, the multi-vessel acquisition arrangement includes a first source vessel 804 and at least one additional source vessel. As illustrated, the additional source vessels include a second source vessel 802 and a third source vessel 803. The first vessel tows a pair of sources, i.e., a first source 810 and a second source 812, in a dual source array configuration and at least a streamer 814 containing a plurality of seismic receivers. The second vessel tows a single third source 806, and the third vessel tows a single fourth source 807. Instead of be located in an in-line configuration along a common first shot line 808, the second vessel is located along a second shot line 809 that is offset in a crossline direction from the first shot line by a given crossline distance, and the third vessel is located along a third shot line 811 this is offset in a crossline direction from the first shot line by a given crossline distance. In this pass, the second and third shot lines are located on opposite sides of the first shot line with each with a given crossline distance of separation that is greater than the crossline distance of separation in either of the first pass or the second pass. The second and third vessels can be moving in alignment with the first vessel or can be located behind or in front of the first vessel. As illustrated, the second and third vessels are located slightly behind the first vessel. In this embodiment, the efficiency of a HD-WAZ acquisition is improved while preserving the inline source sampling

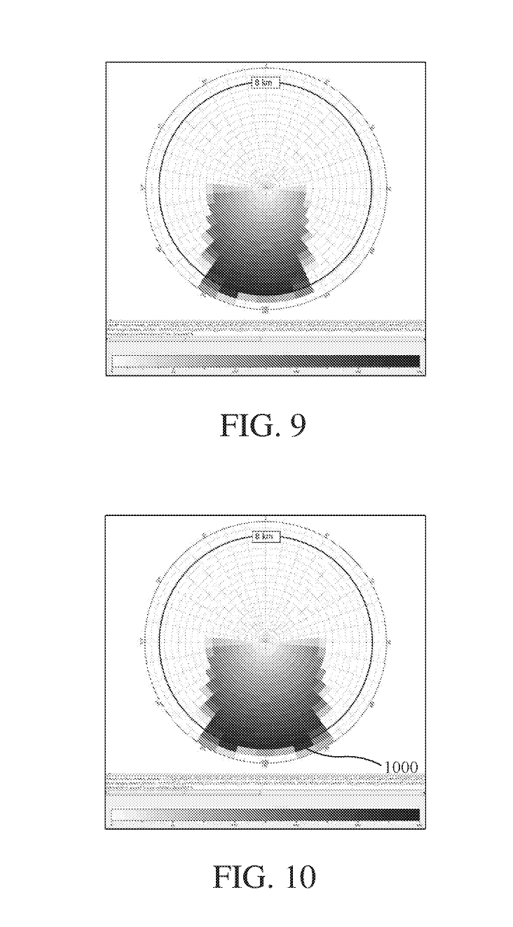

The geometrical illumination for a super-shot obtained with the conventional 3-pass HD-WAZ vessel configuration is illustrated in the rose diagram of FIG. 9. The geometrical illumination for a super-shot obtained with the 3-pass HD-WAZ vessel configuration with a mixed source array configuration is illustrated in the rose diagram of FIG. 10. As illustrated, the rose diagram of FIG. 10 includes an additional recorded tile 1000, which allows increasing the azimuthal distribution of the design, making the configuration more efficient, i.e., larger illumination for the same number of acquisition passes.

Exemplary embodiments are directed to multi-vessel seismic data acquisition systems in accordance with any of the arrangements and geometries illustrated in FIGS. 1, 2 and 4-8. The various arrangements of towing vessels, streamers, sources, shot lines and bin grids illustrated in all of these figures are all included in the multi-vessel seismic data acquisition system. In general, the system includes a first vessel, e.g. 104, towing a streamer, e.g., 114, that contains a plurality of seismic receivers and a pair of seismic sources, e.g., 110, 112 along a first shot line, e.g., 108. In one embodiment, the first vessel 804 tows only the streamer 814 containing the plurality of seismic receivers.

The system also includes at least one additional vessel, e.g., 102, towing a single seismic source e.g., 106. Each additional vessel and single seismic source are spaced from the first vessel and pair of seismic sources in at least one of an inline direction (FIG. 1) and a crossline direction (FIG. 2) to the first shot line, e.g., 108. The pair seismic sources and the seismic receivers define a first midpoint imprint associated to a first bin grid, e.g., 120, having a first bin grid width, e.g., 116 for each bin in the bin grid. In addition, the single seismic source and the seismic receivers define a second midpoint imprint associated to a second bin grid offset from the first bin grid in at least one of the inline direction, e.g., 122, and the crossline direction, e.g., 222. As used herein and illustrated in the figures, the bind grid width refers to the size, i.e., width, of the individual cells or bins within the bind grid as opposed to the entire bin grid.

As illustrated, for example, in FIGS. 1 and 4, in one embodiment, the additional vessel is towing the single seismic source along the first shot line such that the single seismic source is spaced from the first vessel and pair of seismic sources in the inline direction along the first shot line. As illustrated, for example, in FIGS. 2 and 6, in another embodiment, the additional vessel is towing the single seismic source along a second shot line space from the first shot line by a predefined crossline distance, e.g., 211. In one embodiment, the additional vessel and single seismic source are located on the second shot line ahead of a position of the first vessel and pair of seismic sources on the first shot line (FIG. 2).

Referring to FIG. 4, in one embodiment, the seismic spread includes a plurality of streamers 414 containing the seismic receivers and having a crossline distance between adjacent streamers that increase from a lead end 415 to a tail end 417 of the streamer to define a fan shape for the streamer. The pair of seismic sources 410, 412 and the seismic receivers define a first bin grid 420 having a first bin grid width that varies in accordance with the crossline distance increase between adjacent streamer lines. Similarly, the single seismic source 406 and the seismic receivers define a second bin grid 422 offset from the first bin grid in at least one of the inline direction (FIG. 4) and the crossline direction (FIG. 2) and having a second bin grid width that is greater than the first bin grid width and that varies in accordance with the crossline distance increase between adjacent streamer lines. The second bin grid separate from the first bin grid. The fan shaped streamer, while yielding an imprint shape corresponding to the fan shape of the streamer, the resulting bin grids for both near offset and far offset seismic data grids remain rectangular.

In addition to following linear or straight shot lines, any one of the additional vessels can following random or predetermined zig-zag shot lines. As illustrated, for example, in FIGS. 5 and 7, each additional vessel 502, 702, 703 tows the single seismic source 506, 706, 707 along a predetermined zig-zag path 509, 709, 711 to introduce randomization between a location of the single source and seismic receivers in the streamer.

Referring, for example, to FIG. 6, in addition to having just a single additional vessel with a single source, two additional vessels 602, 603 located on opposite sides of the first shot line are included in one embodiment of the additional vessels. The streamer 614 towed by the first vessel 604 has a receiver spread 615 that is a width covered by the plurality of streamers. Each one of the two additional vessels and single seismic sources are spaced from the first vessel and pair of seismic sources in a crossline distance 640, 650 equal to the width of the receiver spread. In one embodiment, the pair of seismic sources 610, 612 and the seismic receivers define a first midpoint imprint 620 associated with a first bin grid having a first bin grid width 616. In addition, the single seismic sources and the seismic receivers define a second midpoint imprint 622 and third midpoint imprint 623 associated with a second bin grid and a third bin grid each offset from the first bin grid in at least one of the inline direction and the crossline direction. The second bin grid has a second bin grid width 618, and a third bin grid has a third bin grid width 619. Both the second and third bin grid widths are greater than the first bin grid width. The second and third bin grid widths can be equal or different widths. The first, second and third bin grids do not overlap in a crossline direction and define a total crossline acquisition width 630 for the multi-vessel seismic data acquisition system. This increased total crossline width provides wider coverage for the seismic data acquisition system, which increases acquisition efficiency while preserving inline sampling.

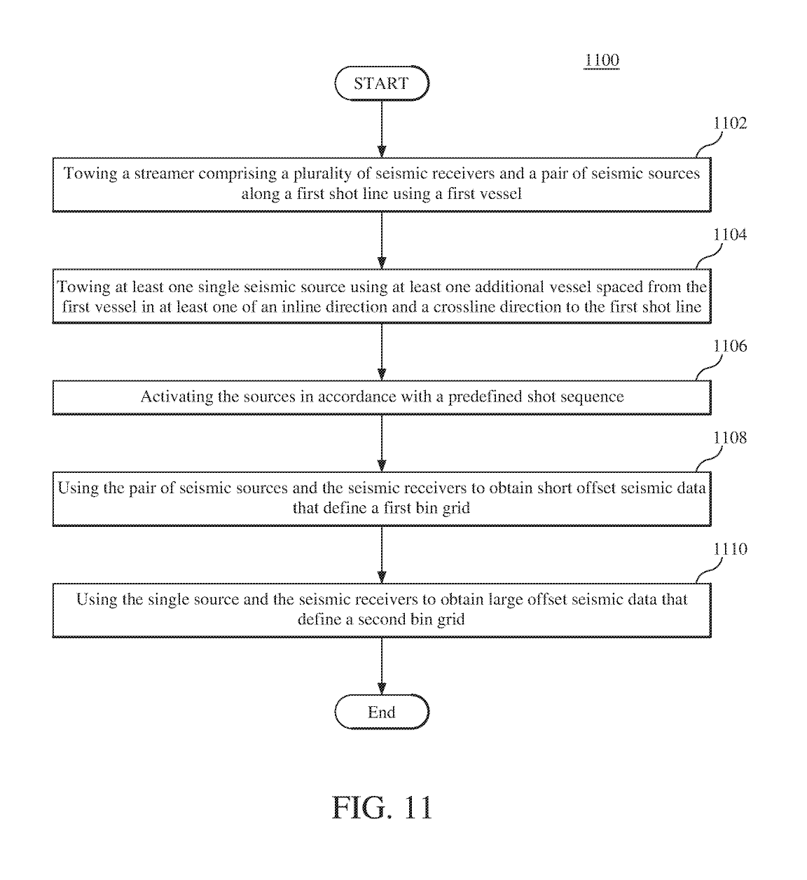

Referring to FIG. 11, exemplary embodiments are also directed to a method for acquiring seismic data 1100 using a multi-vessel seismic data acquisition system in accordance with any one of the configurations shown in FIGS. 1, 2 and 4-8. At least a streamer containing a plurality of seismic receivers and a pair of seismic sources is towed along a first shot line using a first vessel 1102. In addition, at least one single seismic source is towed using at least one additional vessel spaced from the first vessel in at least one of an inline direction and a crossline direction to the first shot line 1104.

In one embodiment, the single seismic source is towed with the additional vessel along the first shot line such that the single seismic source is spaced from the first vessel and pair of seismic sources in the inline direction along the first shot line. In another embodiment, the single seismic source is towed with the additional vessel along a second shot line space from the first shot line by a predefined crossline distance. In addition, the single seismic source is located along the second shot line ahead of a position of the first vessel and pair of seismic sources along the first shot line. In one embodiment, the single seismic source is towed with the additional vessel along a predetermined zig-zag path to introduce randomization between a location of the single source and seismic receivers in the streamer.

All of the sources including the pair of sources and each additional single source are then activated according to a predefined firing or activation sequence 1106. In one embodiment, each source in the pair of sources and each single source are activated using a sequential activation sequence. Alternatively, the pair of sources is activated simultaneously, and the single source is activated after activation of the pair of sources. Other combinations of firings can also be used including firing all sources simultaneously.

The pair seismic sources, following activation, and the seismic receivers are used to obtain short offset seismic data that define a first bin grid 1108, which has a first bin grid width. The single seismic source, following activation, and the seismic receivers are used to obtain large offset seismic data that define a second bin grid 1110, which is offset from the first bin grid in at least one of the inline direction and the crossline direction and has a second bin grid width greater. The second bin grid width is greater than the first bin grid width, and the second bin grid is separate from the first bin grid.

In one embodiment, a fan shape is defined in the spread by arranging the plurality of streamers that contain the seismic receivers to have a crossline distance between adjacent streamers that increases from a lead end to a tail end of the streamer. Therefore, using the pair of seismic sources and the seismic receivers to obtain short offset seismic data will define a first bin grid having a first bin grid width. In addition, using the single seismic source and the seismic receivers to obtain large offset seismic data will define a second bin grid offset from the first bin grid in at least one of the inline direction and the crossline direction. The second bin grid will have a second bin grid width that is greater than the first bin grid width and that varies in accordance with the crossline distance increase between adjacent streamer lines. The imprints of the first and second bin grids are separated, and the grids can be superimposed on each other.

In one embodiment, a seismic vessel is towing at least one streamer comprising a plurality of seismic receivers. Two additional vessels are located on opposite sides of the first shot line, and each tow a single source. Each one of the two additional vessels and single seismic sources are spaced from the first vessel and pair of seismic sources in a crossline distance equal to the width of the receiver spread. The pair of seismic sources and the seismic receivers are used to obtain short offset seismic data that define a first bin grid having a first bin grid width. The single seismic sources and the seismic receivers are used to obtain large offset seismic data that define a second bin grid and a third bin grid each offset from the first bin grid in at least one of the inline direction and the crossline direction. The second bin grid has a second bin grid width, and the third bin grid has a third bin grid width greater than the first bin grid width. The first, second and third bin grids do not overlap in a crossline direction and define a total crossline acquisition width for the multi-vessel seismic data acquisition system. All four of these sources are activated in accordance with a predefined activation sequence. In one embodiment, the pair of sources are activated simultaneously, and the single sources are activated simultaneously after activation of the pair of sources.

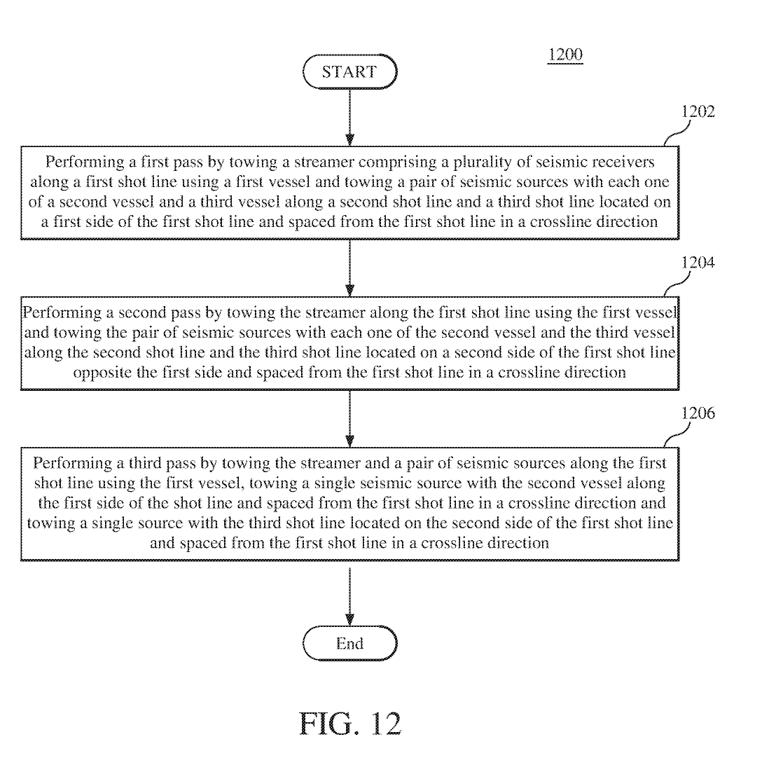

Referring to FIG. 12, exemplary embodiments are also directed to a method for acquiring seismic data using a multi-vessel seismic data acquisition system 1220 with multiple passes and arrangements of vessels and seismic sources as illustrated, for example, in FIG. 8. A first pass is performed by towing at least a streamer containing a plurality of seismic receivers along a first shot line using a first vessel and towing a pair of seismic sources with each one of a second vessel and a third vessel along a second shot line and a third shot line located on a first side of the first shot line and spaced from the first shot line in a crossline direction 1202. A second pass is performed by towing the streamers along the first shot line using the first vessel and towing the pair of seismic sources with each one of the second vessel and the third vessel along the second shot line and the third shot line located on a second side of the first shot line opposite the first side and spaced from the first shot line in a crossline direction 1204. A third pass is performed by towing the streamers and a pair of seismic sources along the first shot line using the first vessel, towing a single seismic source with the second vessel along the first side of the shot line and spaced from the first shot line in a crossline direction and towing a single source with the third vessel along the third shot line located on the second side of the first shot line and spaced from the first shot line in a crossline direction 1206.

Methods and systems in accordance with exemplary embodiments can be hardware embodiments, software embodiments or a combination of hardware and software embodiments. In one embodiment, the methods described herein are implemented as software. Suitable software embodiments include, but are not limited to, firmware, resident software and microcode. In addition, exemplary methods and systems can take the form of a computer program product accessible from a computer-usable or computer-readable medium providing program code for use by or in connection with a computer, logical processing unit or any instruction execution system. In one embodiment, a machine-readable or computer-readable medium contains a machine-executable or computer-executable code that when read by a machine or computer causes the machine or computer to perform a method for acquiring seismic data using a multi-vessel seismic data acquisition system in accordance with exemplary embodiments and to the computer-executable code itself. The machine-readable or computer-readable code can be any type of code or language capable of being read and executed by the machine or computer and can be expressed in any suitable language or syntax known and available in the art including machine languages, assembler languages, higher level languages, object oriented languages and scripting languages.

As used herein, a computer-usable or computer-readable medium can be any apparatus that can contain, store, communicate, propagate, or transport the program for use by or in connection with the instruction execution system, apparatus, or device. Suitable computer-usable or computer readable mediums include, but are not limited to, electronic, magnetic, optical, electromagnetic, infrared, or semiconductor systems (or apparatuses or devices) or propagation mediums and include non-transitory computer-readable mediums. Suitable computer-readable mediums include, but are not limited to, a semiconductor or solid state memory, magnetic tape, a removable computer diskette, a random access memory (RAM), a read-only memory (ROM), a rigid magnetic disk and an optical disk. Suitable optical disks include, but are not limited to, a compact disk-read only memory (CD-ROM), a compact disk-read/write (CD-R/W) and DVD.

The disclosed exemplary embodiments provide a computing device, software and method for method for acquiring seismic data using a multi-vessel seismic data acquisition system. It should be understood that this description is not intended to limit the invention. On the contrary, the exemplary embodiments are intended to cover alternatives, modifications and equivalents, which are included in the spirit and scope of the invention. Further, in the detailed description of the exemplary embodiments, numerous specific details are set forth in order to provide a comprehensive understanding of the invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein. The methods or flowcharts provided in the present application may be implemented in a computer program, software, or firmware tangibly embodied in a computer-readable storage medium for execution by a geophysics dedicated computer or a processor.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

1. A multi-vessel seismic data acquisition system comprising:
a first vessel towing a streamer comprising a plurality of seismic receivers and a pair of seismic sources along a first shot line; and
at least one additional vessel towing only a single seismic source, each additional single seismic source spaced from the pair of seismic sources an offset distance in at least one of an inline direction and a crossline direction to the first shot line to define a first bin grid having a first bin size for the first vessel and a second bin grid having a second bin size for each additional vessel.

2. The system of claim 1, wherein:
the pair seismic sources and the seismic receivers define the first bin grid comprising the first bind size with a first bin grid width; and
the single seismic source and the seismic receivers define the second bin grid offset from the first bin grid in at least one of the inline direction and the crossline direction and comprising the second bin size with a second bin grid width greater than the first bin grid width, the second bin grid separate from the first bin grid.

3. The system of claim 1, wherein the additional vessel is towing the single seismic source along the first shot line such that the single seismic source is spaced from the first vessel and pair of seismic sources in the inline direction along the first shot line.

4. The system of claim 1, wherein:
the additional vessel is towing the single seismic source along a second shot line space from the first shot line by a predefined crossline distance; and
the additional vessel and single seismic source are located on the second shot line ahead of a position of the first vessel and pair of seismic sources on the first shot line.

5. The system of claim 1, wherein:
the streamer containing the seismic receivers comprises a crossline width that increases from a lead end to a tail end of the streamer to define a fan shape;
the pair of seismic sources and the seismic receivers define the first bin grid comprising a first bin grid width; and
the single seismic source and the seismic receivers define the second bin grid offset from the first bin grid in at least one of the inline direction and the crossline direction and comprising a second bin grid width that is greater than the first bin grid width.

6. The system of claim 1, wherein the additional vessel tows the single seismic source along a predetermined zig-zag path to introduce randomization between a location of the single source and seismic receivers in the streamer.

7. The system of claim 1, wherein:
the at least one additional vessel further comprises two additional vessels located on opposite sides of the first shot line;
the streamer comprises a receiver spread comprising a width for the plurality of seismic receivers; and
each one of the two additional vessels and single seismic sources are spaced from the first vessel and pair of seismic sources in a crossline distance equal to the width of the receiver spread.

8. The system of claim 7, wherein:
the pair of seismic sources and the seismic receivers define a first bin grid comprising a first bin grid width;
the single seismic sources and the seismic receivers define a second bin grid and a third bin grid each offset from the first bin grid in at least one of the inline direction and the crossline direction and comprising a second bin grid width and a third bin grid width greater than the first bin grid width; and
the first, second and third bin grids in a crossline direction define a total crossline acquisition width for the multi-vessel seismic data acquisition system.

9. A method for acquiring seismic data using a multi-vessel seismic data acquisition system, the method comprising:
towing a streamer comprising a plurality of seismic receivers and a pair of seismic sources along a first shot line using a first vessel; and
towing at least one single seismic source using at least one additional vessel such that the at least one single source is spaced from the pair of seismic sources an offset distance in at least one of an inline direction and a crossline direction to the first shot line to define a first bin grid having a first bin size for the first vessel and a second bin grid having a second bin size for each additional vessel.

10. The method of claim 9, further comprising
using the pair seismic sources and the seismic receivers to obtain short offset seismic data that define the first bin grid comprising the first bin size having a first bin grid width; and
using the single seismic source and the seismic receivers to obtain large offset seismic data that define the second bin grid offset from the first bin grid in at least one of the inline direction and the crossline direction and comprising the second bin size having a second bin grid width greater than the first bin grid width, the second bin grid separate from the first bin grid.

11. The method of claim 9, further comprising towing the single seismic source with the additional vessel along the first shot line such that the single seismic source is spaced from the first vessel and pair of seismic sources in the inline direction along the first shot line.

12. The method of claim 9, wherein the method further comprises:
towing the single seismic source with the additional vessel along a second shot line space from the first shot line by a predefined crossline distance; and
locating the single seismic source on the second shot line ahead of a position of the first vessel and pair of seismic sources on the first shot line.

13. The method of claim 9, wherein the method further comprises:
defining a fan shaped streamer that contains the seismic receivers to have a crossline width that increases from a lead end to a tail end of the streamer;
using the pair of seismic sources and the seismic receivers to obtain short offset seismic data that define the first bin grid comprising a first bin grid width; and
using the single seismic source and the seismic receivers to obtain large offset seismic data that define the second bin grid offset from the first bin grid in at least one of the inline direction and the crossline direction and comprising a second bin grid width that is greater than the first bin grid width.

14. The method of claim 9, wherein the method further comprises towing the single seismic source with the additional vessel along a predetermined zig-zag path to introduce randomization between a location of the single source and seismic receivers in the streamer.

15. The method of claim 9, further comprising activating each source in the pair of sources and the single source using a sequential activation sequence.

16. The method of claim 9, further comprising:
activating the pair of sources simultaneously; and
activating the single source after activation of the pair of sources.

17. The method of claim 9, wherein:
the streamer comprises a width; and
the method further comprises:
towing two additional vessels on opposite sides of the first shot line; and
spacing each one of the two additional vessels and single seismic sources from the first vessel and pair of seismic sources in a crossline distance equal to the width of the streamer.

18. The method of claim 17, wherein:
using the pair of seismic sources and the seismic receivers to obtain short offset seismic data that define the first bin grid comprising a first bin grid width; and
using the single seismic sources and the seismic receivers to obtain large offset seismic data that define the second bin grid and a third bin grid each offset from the first bin grid in at least one of the inline direction and the crossline direction and comprising a second bin grid width and a third bin grid width greater than the first bin grid width;
wherein the first, second and third bin grids in a crossline direction define a total crossline acquisition width for the multi-vessel seismic data acquisition system.

19. The method of claim 17, wherein the method further comprises:
activating the pair of sources simultaneously; and
activating the single sources simultaneously after activation of the pair of sources.

20. A method for acquiring seismic data using a multi-vessel seismic data acquisition system, the method comprising:
performing a first pass by towing a streamer comprising a plurality of seismic receivers along a first shot line using a first vessel and towing a pair of seismic sources with each one of a second vessel and a third vessel along a second shot line and a third shot line located on a first side of the first shot line and spaced from the first shot line in a crossline direction;
performing a second pass by towing the streamer along the first shot line using the first vessel and towing the pair of seismic sources with each one of the second vessel and the third vessel along the second shot line and the third shot line located on a second side of the first shot line opposite the first side and spaced from the first shot line in a crossline direction; and
performing a third pass by towing the streamer and a pair of seismic sources along the first shot line using the first vessel, towing a single seismic source with the second vessel along the first side of the shot line and spaced from the first shot line in a crossline direction and towing a single source with the third vessel along the third shot line located on the second side of the first shot line and spaced from the first shot line in a crossline direction.
